(19) United States
(12) Patent Application Publication
(10) Pub. No.: US 2015/0363454 A1
(43) Pub. Date: Dec. 17, 2015

(54) Method and Apparatuses for Handling Concurrent Accesses to Data in a Directory

(71) Applicant: TELEFONAKTIEBOLAGET LM ERICSSON (publ), Stockholm (SE)

(72) Inventors: Marta MONTEJO AYALA, Getafe (Madrid) (ES); Antonio INIESTA GONZALEZ, Madrid (ES); Angel NAVAS CORNEJO, Leganes (ES)

(21) Appl. No.: 14/766,793

(22) PCT Filed: Feb. 15, 2013
(86) PCT No.: PCT/EP2013/053139

§ 371 Date: Aug. 10, 2015

(51) Int. Cl. G06F 17/30; H04L 29/08

(52) U.S. Cl. CPC G06F 17/30359; G06F 17/30371; H04L 67/32

(57) ABSTRACT

The present specification faces the issue of detecting collisions caused by concurrent processes which operate on shared data, without compromising bandwidth and system performance. The present specification provides for: a user data repository that, for one or more requests to read data from different application front-ends, provides the data along with a current version value assigned to the data; a first application front-end that, upon determining a data modification, submits a modification request to the user data repository including a first replace indication with the data to be modified, a delete indication with the current version value received, and a second replace indication with a new version data to assign for the data to be modified; and wherein the user data repository accepts the modification if the current version value received from the application front-end matches the current version value at the user data repository, or rejects it, otherwise.

### TECHNICAL FIELD

The present specification generally relates to concurrent accesses to data in a directory; and, more specifically, the invention relates to concurrent accesses with a Lightweight Directory Access Protocol in data layered architecture.

### BACKGROUND

The telecommunications networks face the issue of storing and processing a huge amount of user data for a huge amount of subscribers. Current trends suggest and develop a so-called user data convergence architecture, which is a sort of data layered architecture, for storing and accessing the user data for a huge amount of subscribers.

A user data convergence (UDC) architecture, as specified in 3GPP TS 29.335 V11.1.0, is built up by separating user data from application logic operating on said user data. User data is stored in a logically unique repository, a so-called user data repository (UDR), which allows access from entities handling the application logic, the so-called Front-Ends (FEs). The UDR is a functional entity that acts as a single logical repository of the user data and is unique from FEs perspective, and wherein each FE connects to the UDR through a so-called ‘Ud’ reference point to access the user data.

This UDC architecture can be applied and used by most of the conventional user data directories in telecommunications networks. For example, one or more conventional Home Location Register (HLR), one or more conventional Home Subscriber Server (HSS), one or more Number Portability Register (NPR), one or more Equipment Identity Register (EIR) and others may be provided with a UDC architecture by configuring their respective user data into the UDR and by implementing their respective application logic in a number of dedicated application FE servers, such as one or more HLR-FE servers, one or more HSS-FE servers, one or more NPR-FE servers, one or more EIR-FE servers and others.

The Ud reference point allows the different FEs to create, read, modify and delete user data stored in the UDR via a Lightweight Directory Access Protocol (LDAP), and also supports subscriptions/notifications functionality to allow an FE to be notified via a Simple Object Access Protocol (SOAP) of specific events which may occur on specific user data in the UDR. In particular, the events may be changes on existing user data, addition of user data, and so on. On the other hand, the user data that a particular application FE may accesses in the UDR through the reference point 11d complies with a data structure agreed on between the particular application FE and the UDR.

The UDC architecture conventionally requires a sort of isolation per subscriber process of the operations from the FEs towards the UDR in order to ensure that only one process is updating the same user data for the subscriber at a specific time. The conventional LDAP protocol supports isolation properties in one LDAP update operation (Add, Delete and Modify) because each of these updating operations acts upon an entry and contained attributes.

However, this mechanism is not enough since several concurrent processes in an application FE can read the same data from the UDR and update the data more or less simultaneously without considering other modifications performed by any other concurrent processes.

A possible solution for concurrency is disclosed in U.S. Pat. No. 7,809,838-B2. This publication discloses a mechanism, which makes it use of a collision detection counter (CDC) and a maximum number of collisions to detect (NDC), and whereby updating user data in the UDR is carried out with an LDAP Modify request which includes a number of ADD operations to execute:

add: CDC attribute

value: CDC read value+1

add: CDC attribute

value: CDC read value+2

. . .

. . .

add: CDC attribute

value: CDC read value+NDC

This mechanism guarantees that if a process ‘A’ reads the subscriber profile when attribute CDC has value x, and a number N of concurrent processes also read the same subscriber data profile (CDC=x) and modifies it prior to finishing the process A, when process A tries to perform the modification (LDAP Modify) of the subscriber profile, this operation is going to fail if N<=NDC.

There are some applications that hold user data shared by a number of subscribers. One instance is the Policy and Charging Rules Function (PCRF) of a Policy and Charging Control (PCC) architecture specified in 3GPP TS 23.203 V11.8.0. The PCRF provides usage monitoring function for a plurality of subscribers that share a common data plan, i.e. PCRF handles a counter for data usage consumption that is shared by a bunch of subscribers. Other instances may be a corporation subscription that holds a shared data plan for all the employees, a university that has a shared data plan for the computers that the students use, or scenarios in the field of Machine-To-Machine (M2M) communications, wherein a unique subscription is hold for thousands of devices like sensors or the like. Therefore, these families, corporations, or multiple-subscriptions may have hundreds or even thousands of members.

Whilst the above mechanism is found to be effective and appropriate for low NDC values, one can easily figure out that where the number of concurrent processes is much higher (let us say NDC in the range of hundreds or higher), the performance of the system would be seriously penalized if every LDAP Modify consists of hundreds of ADD operations.

There is thus a need to provide a different mechanism that allows detecting collisions caused by any number of concurrent processes operating on the same shared data, without compromising the bandwidth demanded and performance of the system, especially, where the number of concurrent processes is high.

### SUMMARY

The present specification is aimed to at least minimize the above drawbacks and provides for a new method of handling concurrent LDAP processes triggered from different LDAP clients towards a UDR, and corresponding apparatuses arranged to support said method.

In accordance with a first aspect of the present specification, there is provided for a new method of handling concurrent accesses at an entry in a UDR, wherein the entry in the UDR is concurrently accessed with Lightweight Directory Access Protocol, hereinafter LDAP, requests from one or more FE servers equipped with respective LDAP-clients.

This method comprises the steps of: receiving, at the UDR from the one or more FE servers, one or more LDAP search requests to read a set of user data for a user; providing, from the UDR to the one or more FE servers, the set of user data along with a current version value assigned to the set of user data; each FE server receiving the set of user data along with the current version value, processing the set of user data; upon determining a modification of the set of user data, by an FE server amongst the one or more FE servers, said FE server submitting to the UDR an LDAP modify request which includes: a first replace indication with new data to replace in the set of user data, a delete indication with the current version value, and a second replace indication with a new version value; upon receiving the LDAP modify request, checking at the UDR whether the current version value received with the delete indication matches the current version value assigned at the UDR to the set of user data; and where there is a match: replacing the current version value assigned at the UDR to the set of user data by the new version value received with the second replace indication, and replacing corresponding data in the set of user data by the new data received with the first replace indication; or where there is not a match: rejecting the LDAP modify request.

In particular, where there is a match between the current version value received with the delete indication and the current version value assigned at the UDR to the set of user data, the method may further comprise a step of submitting from the UDR to the FE server a successful LDAP modify result.

In an embodiment of the invention, the step of rejecting the LDAP modify request may include a step of providing, from the UDR to the FE server, the set of user data along with the current version value assigned to the set of user data.

In an embodiment of the invention, the method may further comprise a step of assigning one or more sets of user data to respective one or more current version values for each user at the UDR. Alternatively, the UDR may assign an initial version value to each set of user data before providing it as result upon a first LDAP search requests to read said set of user data.

Complementary to any alternative above and especially advantageous where the processing of the set of user data at the FE servers cannot be carried out without interruptions, after receiving at each FE server the set of user data along with the current version value, the method may further comprise a step of assigning at each FE server the current version value to the set of user data.

Complementary to any alternative above, the method may further comprise a step of determining at each FE server, during or after processing the set of user data received, the new data to replace in the set of user data and the new version value.

Complementary to any alternative above, in an embodiment of the invention the method may further comprise a step of assigning to each of the one or more FE servers a set of new version values to be used for successive LDAP modify requests, the set of new version values being different for each of the one or more FE servers. Alternatively, each FE server may assign a new version value on its own to each set of user data to be modified with each successive LDAP modify request.

Complementary to any alternative above, at least one FE server, amongst the one or more FE servers, may include an instance of a PCRF for controlling user quota and accumulated usage consumption for the user. Such at least one FE server including an instance of a PCRF is hereinafter referred to as a PCRF-FE server.

In an embodiment of the invention, the set of user data for the user may include one or more counters with accumulated usage consumptions. Additionally, the set of user data for the user may further include a user quota value indicating a maximum authorized for the accumulated usage consumptions.

Complementary or alternatively to this embodiment, a user may have a corporative subscription with a plurality of subscribers at the UDR. Where this is the case, the set of user data for the user may include one or more counters with accumulated usage consumptions for some or all subscribers in the corporative subscription. Additionally, the set of user data for the user may further include a user quota value indicating a maximum authorized for the accumulated usage consumptions of the some or all subscribers in the corporative subscription.

In accordance with a second aspect of the present specification, there is provided for a new UDR for handling concurrent accesses with LDAP requests at an entry in the UDR, from one or more FE servers equipped with respective LDAP-clients.

This UDR comprises: a receiver for receiving, from the one or more FE servers, one or more LDAP search requests to read a set of user data for a user; and a sender for providing, to the one or more FE servers, the set of user data along with a current version value assigned to the set of user data; wherein the receiver is adapted for receiving, from at least one amongst the one or more FE servers, an LDAP modify request which includes: a first replace indication with new data to replace in the set of user data, a delete indication with the current version value, and a second replace indication with a new version value.

This UDR also comprises a processing unit for checking whether the current version value received with the delete indication matches the current version value assigned at the UDR to the set of user data; and where there is match, the processing unit is adapted for: replacing the current version value assigned at the UDR to the set of user data by the new version value received with the second replace indication, and replacing corresponding data in the set of user data by the new data received with the first replace indication; or where there is not a match, the processing unit and the sender are adapted for: rejecting the LDAP modify request.

In particular, where there is a match between the current version value received with the delete indication and the current version value assigned at the UDR to the set of user data, the sender of the UDR may be adapted for submitting to the FE server a successful LDAP modify result.

In an embodiment of the invention, as rejecting the LDAP modify request, the processing unit and the sender may be adapted for providing to the FE server the set of user data along with the current version value assigned to the set of user data.

Aligned with the above method, the UDR may further comprise storage for assigning one or more sets of user data to respective one or more current version values for each user.

Also aligned with the above method, at least one FE server, amongst the one or more FE servers submitting LDAP search requests and LDAP modify requests to the UDR, may include an instance of a PCRF for controlling user quota and accumulated usage consumption for the user. Such at least one FE server including an instance of a PCRF is hereinafter referred to as a PCRF-FE server.

As already commented above and also applicable to the UDR, in an embodiment of the invention, the set of user data for the user may include one or more counters with accumulated usage consumptions. Additionally, the set of user data for the user may further include a user quota value indicating a maximum authorized for the accumulated usage consumptions.

Complementary or alternatively to the previous embodiment, a user may have a corporative subscription with a plurality of subscribers at the UDR. Where this is the case, the set of user data for the user may include one or more counters with accumulated usage consumptions for some or all subscribers in the corporative subscription. Additionally, the set of user data for the user may further include a user quota value indicating a maximum authorized for the accumulated usage consumptions of the some or all subscribers in the corporative subscription.

In accordance with a third aspect of the present specification, there is provided for a new FE server for accessing an entry in a UDR with LDAP.

This FE server is equipped with an LDAP-client and comprises: a sender for submitting to the UDR one or more LDAP search requests to read a set of user data for a user; a receiver for receiving the set of user data along with a current version value for the set of user data; a processing unit for processing the set of user data, and for determining a modification of the set of user data; and wherein the sender is adapted for submitting to the UDR an LDAP modify request which includes: a first replace indication with new data to replace in the set of user data, a delete indication with the current version value, and a second replace indication with a new version value.

In an embodiment of the invention especially advantageous where the processing of the set of user data at the FE servers cannot be carried out without interruptions, each FE server may further comprise storage for assigning the current version value to the set of user data received from the UDR.

In particular, the processing unit of each FE server may be adapted for determining the new data to replace in the set of user data, and for determining the new version value to be assigned to the set of user data.

Complementary to any alternative above, in an embodiment of the invention the processing unit of each FE server may be adapted for assigning a new version value on its own to each set of user data to be modified with each successive LDAP modify request.

Complementary or alternatively to the previous embodiment, the storage of each FE server may be adapted for storing a set of version values assigned to the FE server and to be used as new version values for successive LDAP modify requests, wherein the set of new version values may be different for each of the one or more FE servers.

Complementary to any alternative above, at least one FE server, amongst the one or more FE servers, may include an instance of a PCRF for controlling user quota and accumulated usage consumption for the user. Such at least one FE server including an instance of a PCRF is hereinafter referred to as a PCRF-FE server.

As already commented above and especially useful for PCRF-FE servers, in an embodiment of the invention the set of user data for the user may include one or more counters with accumulated usage consumptions. Additionally, the set of user data for the user may further include a user quota value indicating a maximum authorized for the accumulated usage consumptions.

Complementary or alternatively to the previous embodiment, a user may have a corporative subscription with a plurality of subscribers at the UDR. Where this is the case, the set of user data for the user may include one or more counters with accumulated usage consumptions for some or all subscribers in the corporative subscription. Additionally, the set of user data for the user may further include a user quota value indicating a maximum authorized for the accumulated usage consumptions of the some or all subscribers in the corporative subscription.

On the other hand, the invention may be practised by a computer program, in accordance with a fourth aspect of the invention, the computer program being loadable into an internal memory of a computer with input and output units as well as with a processing unit, and comprising executable code adapted to carry out the above method steps. In particular, this executable code may be recorded in a carrier readable in the computer.

### BRIEF DESCRIPTION OF THE DRAWINGS

The features, objects and advantages of the invention will become apparent by reading this description in conjunction with the accompanying drawings, in which:

FIG. 1 shows an exemplary UDC architecture with a UDR and a number of FEs, which in particular may respectively include instances of a PCRF, a HLR, an EIR, a HSS and an NPR.

FIG. 2 basically represents a method of handling concurrent LDAP accesses from a number of FEs towards a UDR.

FIG. 3 shows exemplary further sequences of actions to be carried out upon detecting a concurrent access in accordance with embodiments of the invention.

FIG. 4 shows an exemplary configuration of the UDR with exemplary sets of user data for one or more subscriber in accordance with embodiments of the invention.

FIG. 5 shows exemplary configurations of several FEs with exemplary sets of new version values to be used for successive LDAP modify requests in accordance with embodiments of the invention.

FIG. 6 shows a basic component structure of an FE server in accordance with embodiments of the invention.

FIG. 7 shows a basic component structure of a UDR in accordance with embodiments of the invention.

FIGS. 8A, 8B and 8C illustrate an exemplary application of the method illustrated in FIG. 1 in a particular scenario where several PCRFs of the PCC architecture trigger concurrent accesses to the UDR for controlling overall quota and accumulated usage consumption for a subscription.

### DETAILED DESCRIPTION

The following describes currently preferred embodiments of a UDR, an FE server and a method of handling concurrent LDAP processes triggered from one or more FE servers equipped with respective LDAP clients towards the UDR.

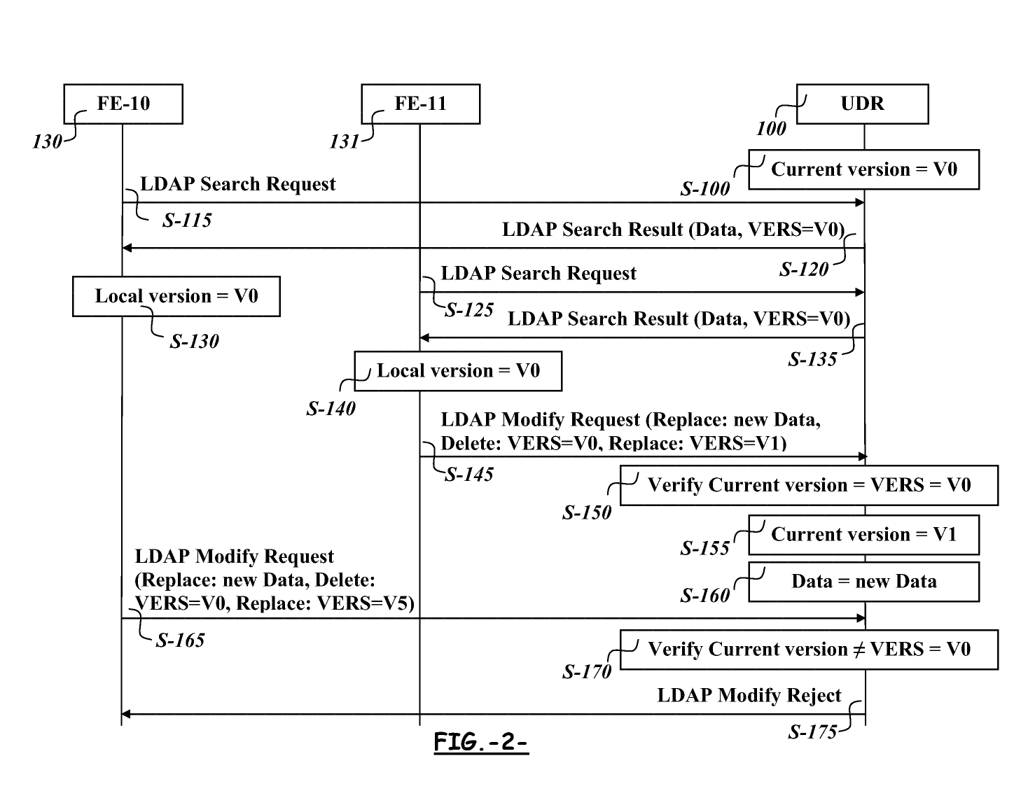

FIG. 2 illustrates an embodiment of this method. The sequence of actions illustrated in FIG. 2 starts with a step S-100 of setting of a current version value, e.g. ‘V0’, to a given set of user data of reference, namely the set of user data 16j, at the UDR 100. This step may be a very first step to start the UDR up and running, or may be the consequence of a previous chain of actions, as the ones explained in the following, to achieve the setting of a new current version value like, for example, in step S-155. In this respect, each particular set of user data available at the UDR is assigned a particular current version value.

That is, the method illustrated with reference to FIG. 2 assumes that the current version value assigned to a particular set of user data 16j at the UDR 100 is ‘V0’.

In this situation, a first FE server 130 sends during a step S-115, and a second FE server 131 sends during a step S-125, respective LDAP search requests to read a same set of user data 16j for a user. The UDR 100 receiving said LDAP search requests returns to the first FE server 130 and to the second FE server 131 respective LDAP search results during steps S-120 and S-135. These LDAP search results include the requested set of user data 16j along with current version value V0 assigned to said set of user data.

Both first and second FE servers 130-131 receiving the set of user data along with the current version value, start processing the received set of user data and may save the associated current version value V0 as a current local version during respective steps S-130 and S-140.

In particular, the processing of the received set of user data may take a different time at each FE server and, in this exemplary illustration, the second FE server 131 is the first one in determining a modification of the received set of user data as a result of the processing and that should be updated in the UDR.

Then, the second FE server 131 submits to the UDR 100, during a step S-145, an LDAP modify request which includes: a first replace indication with new data to replace in the set of user data, that is, the new data determined during the processing of the received set of user data; a delete indication with the current version value, that is, the value V0 previously received; and a second replace indication with a new version value, that is, a new version value V1 which the second FE server 131 has exemplary assigned to the set of user data once modified.

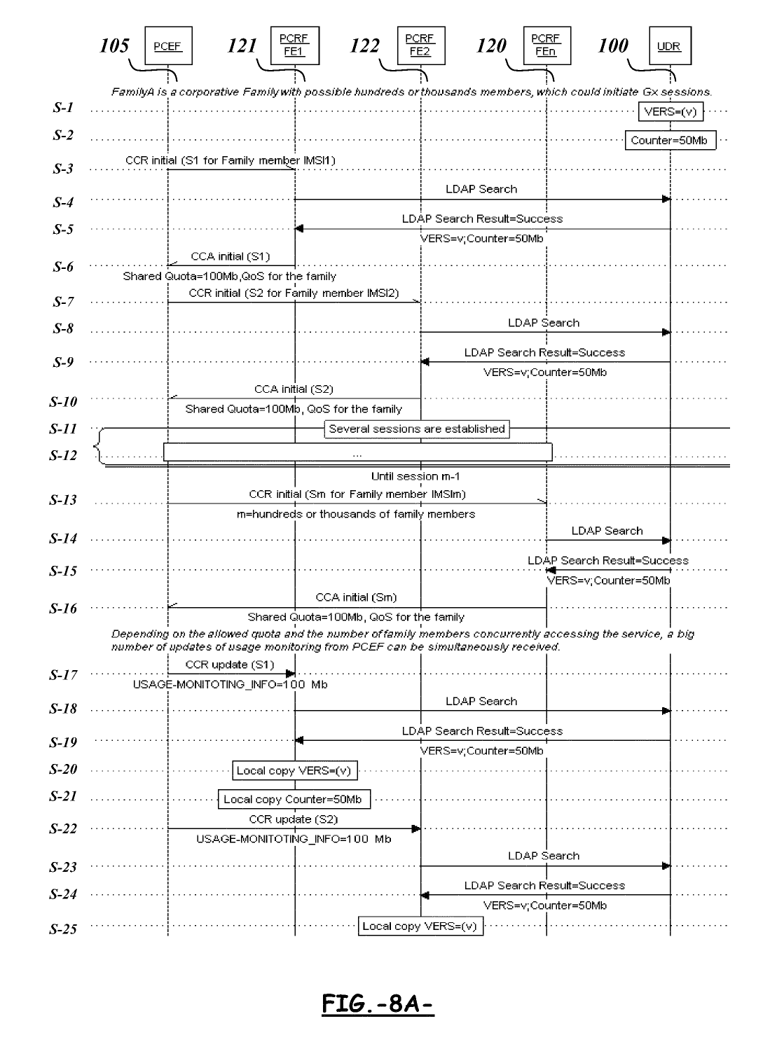

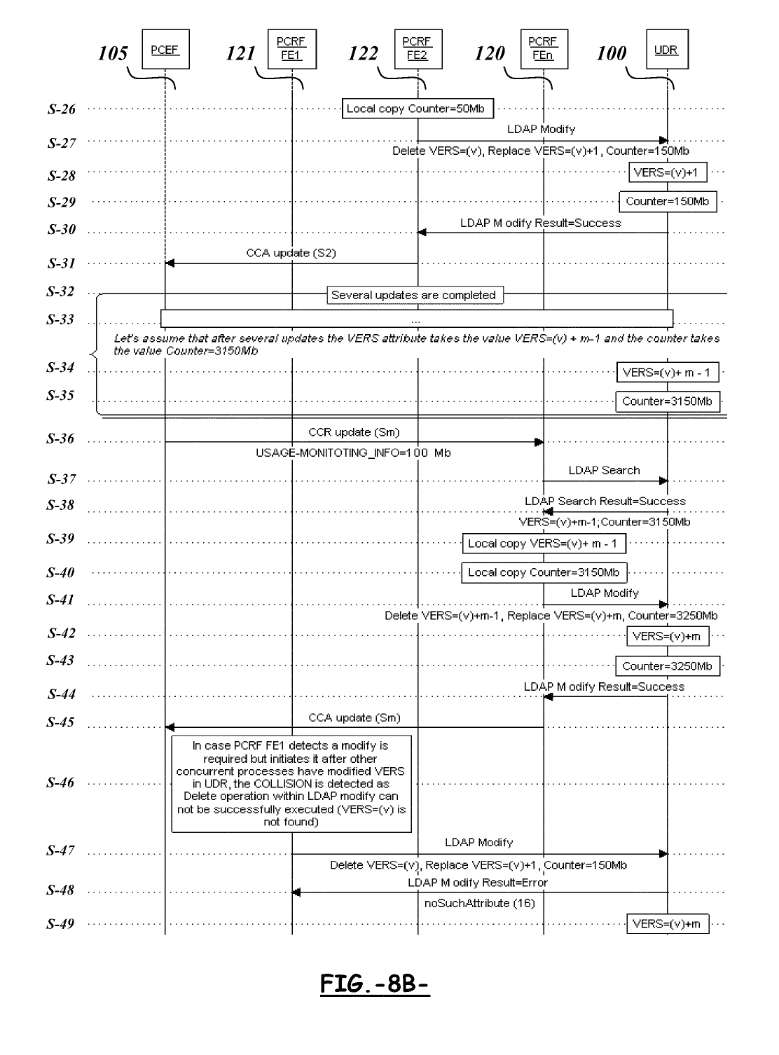

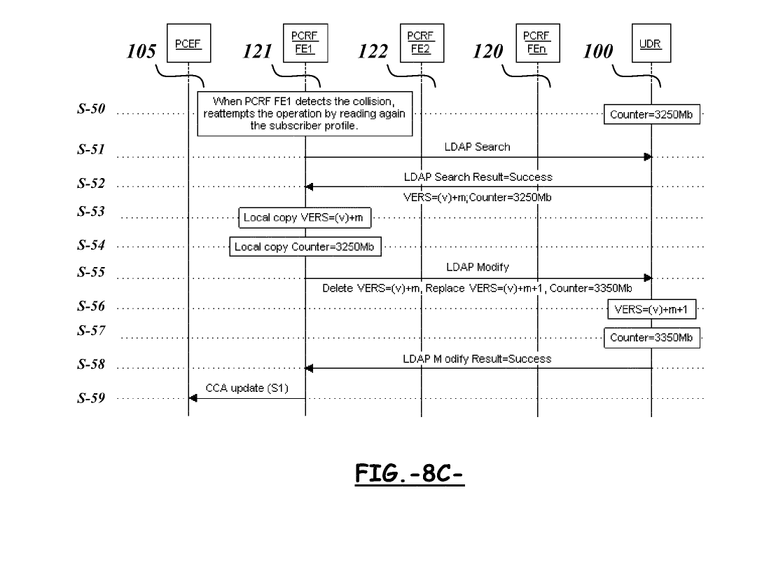

Upon receiving the LDAP modify request, the UDR 100 checks during a step S-150 whether the current version value received with the delete indication, namely V0, matches the current version value lately assigned at the UDR (during previous step S-100) to the set of user data, namely V0. Where a match is verified, as in the present case, the UDR 100 replaces during a step S-155 the current version value V0 assigned to the set of user data 16j at the UDR (during the previous step S-100) by the new version value V1 received with the second replace indication, and the UDR 100 replaces during a step S-160 corresponding data in the set of user data by the new data received with the first replace indication. In addition, where the LDAP modify request has been successfully executed, the UDR 100 may return a successful LDAP modify result to the second FE server 131, which is not illustrated in FIG. 2 but it is illustrated in FIG. 8A-8C for a particular embodiment.

That is, as a result of the last actions carried out at the UDR upon verifying that the current version value received with the delete indication, namely V0, matches the current version value last assigned at the UDR, the current set of user data 16j has been modified and is now associated to a current version value V1 at the UDR.

In this exemplary sequence of actions, the processing of the set of user data 16j originally received by the first FE server 130 has lasted longer than the processing by the second FE server 131. In this situation, the first FE server 130 is the second one in determining a modification of the originally received set of user data, as a result of the processing, and that should be updated in the UDR.

Then, the first FE server 130 submits to the UDR 100, during a step S-165, an LDAP modify request which includes: a first replace indication with new data to replace in the set of user data, that is, the new data determined during the processing of the received set of user data; a delete indication with the current version value, that is, the value V0 previously received; and a second replace indication with a new version value, that is, a new version value V5 which the first FE server 130 has exemplary assigned to the set of user data once modified.

Upon receiving the LDAP modify request, the UDR 100 checks during a step S-170 whether the current version value received with the delete indication, namely V0, matches the current version value lately assigned at the UDR (during previous step S-155) to the set of user data, namely V1. Where such match cannot be verified, as in the present case, the UDR 100 refuses the modification and returns during a step S-175 an LDAP modify reject to the first FE server 130.

In other words, the UDR 100 has solved the concurrency of more than one attempt to modify user data at an entry in the UDR by allowing only the modification by a first process to notify of such modification. The concurrent one or more processes that have got the rejection should attempt again to obtain the last and fresh version of the set of user data and proceed as described above.

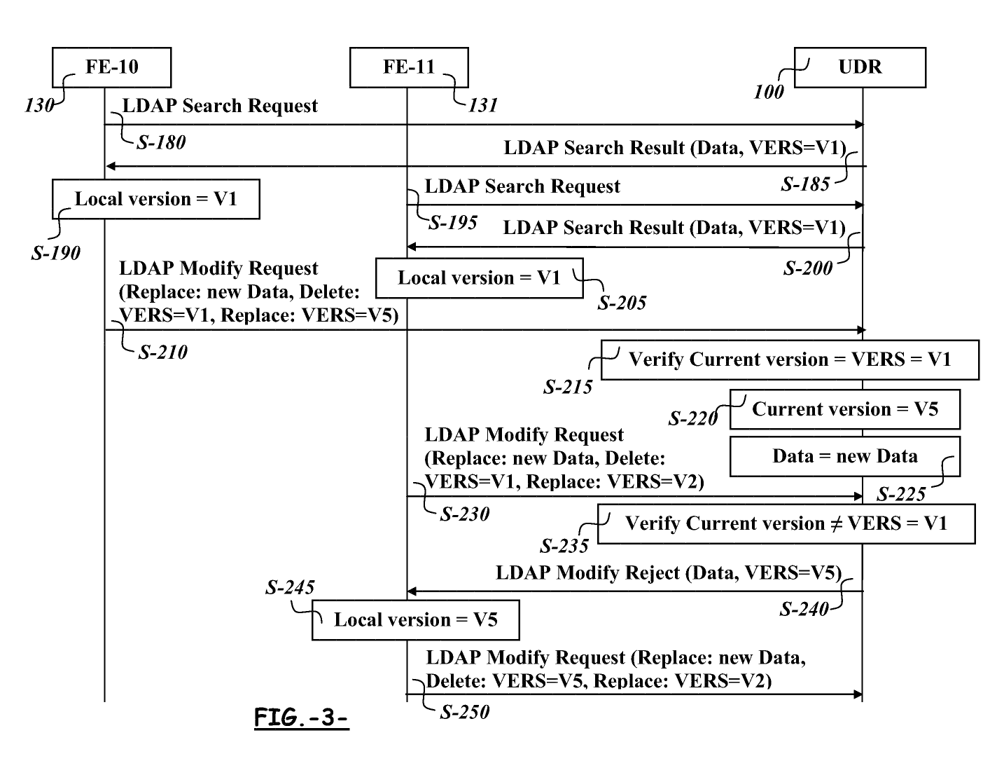

Nevertheless, different embodiments are provided for by the present specification in order to obtain the last version of the set of user data by other concurrent processes, as FIG. 3 illustrates.

As illustrated in FIG. 3, the first FE server 130, which had received during the step S-175 the LDAP modify reject, newly submits during a step S-180 an LDAP search request to read the same set of user data 16j for the user. The UDR 100 receiving said LDAP search request returns to the first FE server 130 a corresponding LDAP search result during a step S-185. This LDAP search result includes the requested set of user data 16j, which had been previously modified during the step S-160 illustrated in FIG. 2, along with current version value V1, which had been previously assigned during the step S-155 illustrated in FIG. 2 to the modified set of user data 16j.

Still with reference to FIG. 3, the first FE server 130 receiving the set of user data along with the current version value starts processing the received set of user data and may save the associated current version value V1 as a current local version during a step S-190.

Whilst the first FE server 130 processes the set of user data, the second FE server 131, which had successfully triggered the previous LDAP modify request during the step S-145 illustrated in FIG. 2, newly submits during a step S-195 an LDAP search request to read the same set of user data 16j for the user. The UDR 100 receiving said LDAP search request returns to the second FE server 131 a corresponding LDAP search result during a step S-200. This LDAP search result includes, as for the first FE server 130, the requested set of user data 16j, which had been previously modified during the step S-160 illustrated in FIG. 2, along with current version value V1, which had been previously assigned during the step S-155 illustrated in FIG. 2 to the modified set of user data 16j.

Still with reference to FIG. 3, the second FE server 131 receiving the set of user data along with the current version value also starts processing the received set of user data and may also save the associated current version value V1 as a current local version during a step S-205.

In this exemplary case, it is the first FE server 130 the first one in determining a modification of the received set of user data as a result of the processing and that should be updated in the UDR.

Then, the first FE server 130 submits to the UDR 100, during a step S-210, an LDAP modify request which includes: a first replace indication with new data to replace in the set of user data, that is, the new data determined during the processing of the received set of user data; a delete indication with the current version value, that is, the value V1 previously received during step S-185; and a second replace indication with a new version value, that is, a new version value V5 which the first FE server 130 has exemplary assigned to the set of user data once modified.

Upon receiving the LDAP modify request, the UDR 100 checks during a step S-215 whether the current version value received with the delete indication, namely V1, matches the current version value lately assigned at the UDR (during previous step S-155 illustrated in FIG. 2) to the set of user data, namely V1. Where a match is verified, as in the present case, the UDR 100 replaces during a step S-220 the current version value V1 assigned to the set of user data 16j at the UDR (during the previous step S-155 illustrated in FIG. 2) by the new version value V5 received with the second replace indication, and the UDR 100 eventually replaces during a step S-225 corresponding data in the set of user data by the new data received with the first replace indication. In addition, where the LDAP modify request has been successfully executed, the UDR 100 may return a successful LDAP modify result to the first FE server 130, which is not illustrated in FIG. 3 but it is illustrated in FIG. 8A-8C for a particular embodiment.

That is, as a result of the last actions carried out at the UDR upon verifying that the current version value received with the delete indication, namely V1, matches the current version value last assigned at the UDR, the current set of user data 16j has been modified and is now associated to a current version value V5 at the UDR.

In this exemplary sequence of actions, it is the second FE server 131 the one which later determines a modification of the originally received set of user data, as a result of the processing, and that should be updated in the UDR.

Then, the second FE server 131 submits, during a step S-230, to the UDR 100 an LDAP modify request which includes: a first replace indication with new data to replace in the set of user data, that is, the new data determined during the processing of the received set of user data; a delete indication with the current version value, that is, the value V1 previously received during the step S-200; and a second replace indication with a new version value, that is, a new version value V2 which the second FE server 131 has exemplary assigned to the set of user data once modified.

Upon receiving the LDAP modify request, the UDR 100 checks during a step S-235 whether the current version value received with the delete indication, namely V1, matches the current version value lately assigned at the UDR (during previous step S-220) to the set of user data, namely V5. Where such match cannot be verified, as in the present case, the UDR 100 refuses the modification and returns during a step S-240 an LDAP modify reject to the second FE server 131.

In an embodiment of the invention disclosed above with reference to the LDAP modify reject submitted in step S-175, upon receiving such LDAP modify reject at the first FE server, such first FE server re-submits again, as in step S-180, the LDAP search request that triggered the further attempt to modify data and the receipt of the LDAP modify reject.

In another embodiment, the LDAP modify reject returned during step S-240 from the UDR 100 to the second FE server 131 includes the previously modified set of user data 16j, which had been modified during the step S-225, along with the current version value V5, which had been previously assigned during the step S-220 to the modified set of user data 16j.

This another embodiment allows the second FE server 131 to immediately start the processing of the received set of user data, without needs for re-submitting again the LDAP search request; and, as explained for other embodiments, the second FE server 131 may also save the associated current version value V5 as a current local version during a step S-245.

In other words, those FE servers which are adapted to receive an LDAP modify reject, which includes the set of user data 16j more recently modified along with the current version value more recently assigned, do neither need to re-submit the LDAP search request nor wait for the response, gain time for processing the received set of user data and are thus in a better position for winning the concurrent access.

Thus, as illustrated in FIG. 3, the second FE server 131 may process the set of user data received with the LDAP modify reject in step S-240 and, upon determining a modification of the received set of user data, may submit during a step S-250 to the UDR 100 an LDAP modify request which includes: a first replace indication with new data to replace in the set of user data, that is, the new data determined during the processing of the received set of user data; a delete indication with the current version value, that is, the value V5 previously received during the step S-240; and a second replace indication with a new version value, that is, the new version value V2 which the second FE server 131 has exemplary assigned to the set of user data once modified.

In order to carry out the above method of handling concurrent LDAP processes triggered from one or more FE servers equipped with respective LDAP clients towards the UDR, the present specification provides for an enhanced UDR 100 and one or more enhanced FE servers 120-132.

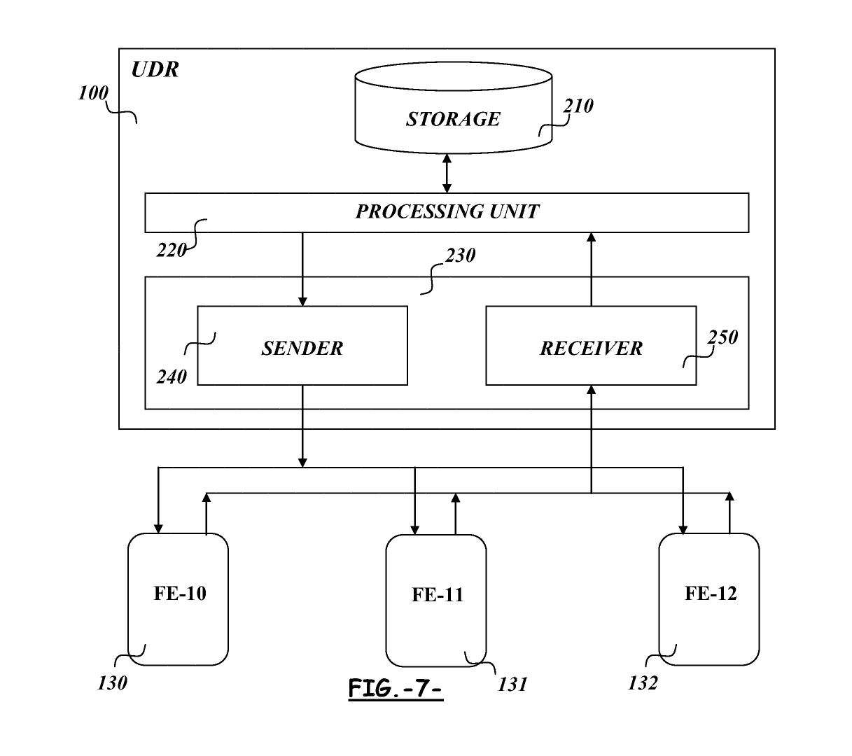

There is thus provided for a UDR 100 as basically illustrated in FIG. 7, for handling concurrent accesses with LDAP requests at an entry in the UDR from the one or more FE servers 120-132 equipped with respective LDAP-clients, which comprises: a receiver 250 for receiving, from the one or more FE servers, one or more LDAP search requests to read a set of user data 16j for a user; and a sender 240 for providing, to the one or more FE servers, the set of user data along with a current version value assigned to the set of user data.

The receiver 250 of the UDR 100 is also adapted for receiving, from at least one amongst the one or more FE servers, an LDAP modify request which includes: a first replace indication with new data to replace in the set of user data, a delete indication with the current version value, and a second replace indication with a new version value; and the UDR 100 also comprises a processing unit 220 for checking whether the current version value received with the delete indication matches the current version value assigned at the UDR to the set of user data.

In this respect, where there is match between the current version value received with the delete indication and the current version value assigned at the UDR to the set of user data, the processing unit 220 is adapted for: replacing the current version value assigned at the UDR to the set of user data by the new version value received with the second replace indication, and replacing corresponding data in the set of user data by the new data received with the first replace indication; whereas, if such match does not occur, the processing unit 220 and the sender 240 cooperate and are adapted for: rejecting the LDAP modify request. In particular, rejecting the LDAP modify request may be carried out by submitting a corresponding LDAP modify reject.

In particular, the sender 240 and the receiver 250 may be implemented with a single and integral input/output unit 230.

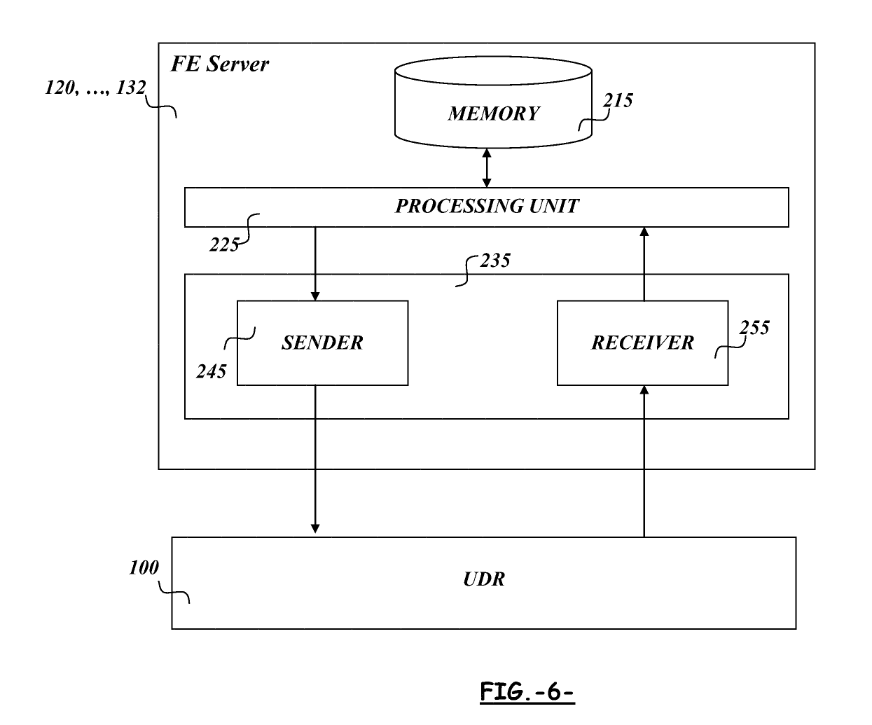

There is also provided for an FE server 120-132 as basically illustrated in FIG. 6, for accessing an entry in the UDR 100 with LDAP, the FE server equipped with an LDAP-client and comprising: a sender 245 for submitting to the UDR 100 one or more LDAP search requests to read a set of user data 16j for a user; a receiver 255 for receiving the set of user data along with a current version value for the set of user data; and a processing unit 225 for processing the set of user data, and for determining a modification of the set of user data.

The sender 245 of this FE server is adapted, where the processing unit 225 of the FE server determines a modification of the set of user data, for submitting to the UDR 100 an LDAP modify request which includes: a first replace indication with new data to replace in the set of user data, a delete indication with the current version value, and a second replace indication with a new version value.

Also in this case and in particular, the sender 245 and the receiver 255 may be implemented with a single and integral input/output unit 235.

Particularly useful for the case where an FE server may save the associated current version value as a current local version, for instance during steps S-130, S-140, S-190, S-205 and S-245 in FIG. 2 or FIG. 3, the FE server 120-132 provided for in the present specification, and illustrated in FIG. 6, further comprises storage 215 for assigning the current version value to the set of user data.

This storage 215, for the purpose of assigning the current version value to the set of user data may be a volatile memory such as a conventional RAM; or, where the storage 215 is wanted to be shared for more static configuration purposes, the storage 215 may be implemented with a non-volatile memory, hard disk, optical disc, magnetic tape, holographic memory driver, a flash-memory or the like.

Regarding the new version value that each FE server may send with the second replace indication and included in each LDAP modify request, as illustrated in FIG. 2 and FIG. 3, nothing in this specification prevents from two different FE servers 131 and 132 using and being coincident in submitting a same new version value in a respective LDAP modify request. In fact, since the key value to verify at the UDR, before accepting any data modification, is the current version value received with the delete indication, a coincident new version value between two or more LDAP modify requests should not offer major problems if implemented with a cyclical counter with a sufficiently large range of values.

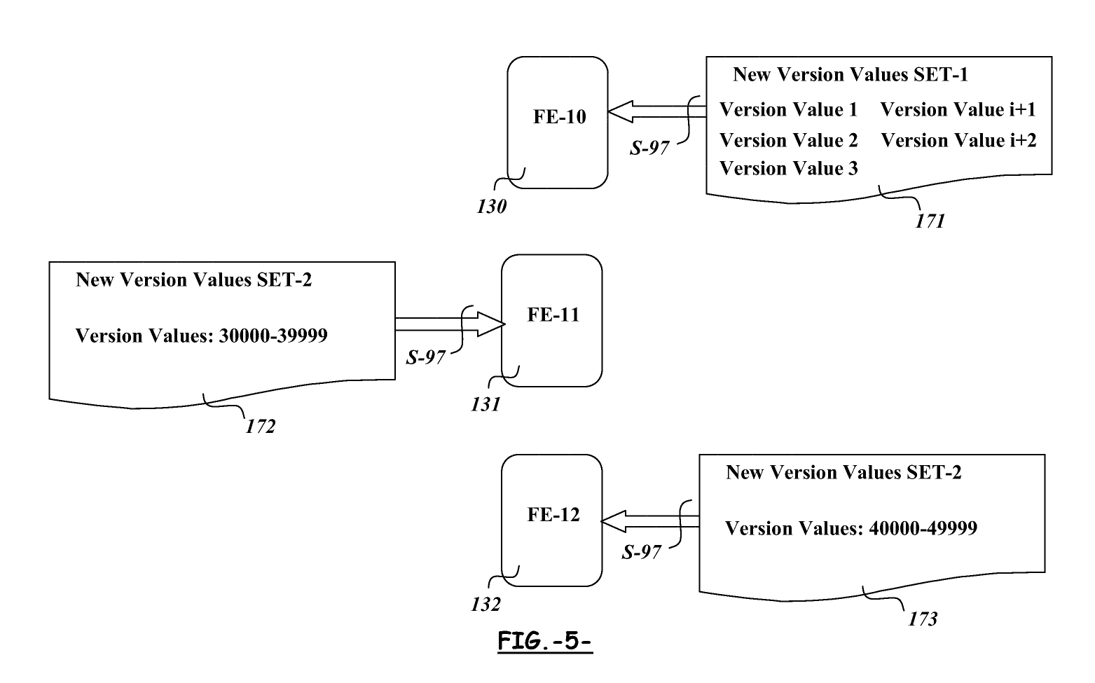

Nevertheless, for the sake of a more accurate distribution of values, as well as for tracking successful and unsuccessful treatments of LDAP modify requests, the present specification further provides for previously assigning, during a step S-97 illustrated in FIG. 5, to each of the one or more FE servers a set of new version values 171-173 to be used for successive LDAP modify requests, the set of new version values being different for each of the one or more FE servers.

To this end, the storage 215 of each FE server may be adapted for storing a set of version values 171-173 assigned to the FE server and to be used as new version values for successive LDAP modify requests. Where this is the case, and in order to save configuration time whenever the FE server is switched on and set up, the storage 215 is preferably implemented with a non-volatile memory, hard disk, optical disc, magnetic tape, holographic memory driver, a flash-memory or the like.

Alternatively, the storage 215 may comprise: a volatile memory the purpose of assigning the current version value to the set of user data as a current local version, and a non-volatile memory for storing the set of version values 171-173 assigned to the FE server and to be used as new version values for successive LDAP modify requests.

Moreover, irrespective of whether the storage 215 is or is not provided for storing the set of version values 171-173 assigned to the FE server, each FE server is adapted for determining, during or after processing the set of user data received, the new data to replace in the set of user data and the new version value. To this end, the processing unit 225 of each FE server may be adapted for determining the new data to replace in the set of user data, and for determining the new version value to be assigned to the set of user data. In particular, where the storage 215 stores the set of version values 171-173 assigned to the FE server, the processing unit 225 will fetch a value next to the last one used in a previous LDAP modify request; whereas, if no specific version value series has been assigned, the processing unit 225 may assigns a new version value in accordance with the logic implemented in the FE server, for example but not limited to, by selecting a random value.

On the other hand, given that the UDR provided for by the present specification may be used as user data repository by a plurality of dedicated and specific application FE servers, one or more amongst the FE servers may include, in accordance with some embodiments, respective instances of a PCRF for controlling user quota and accumulated usage consumption for the user.

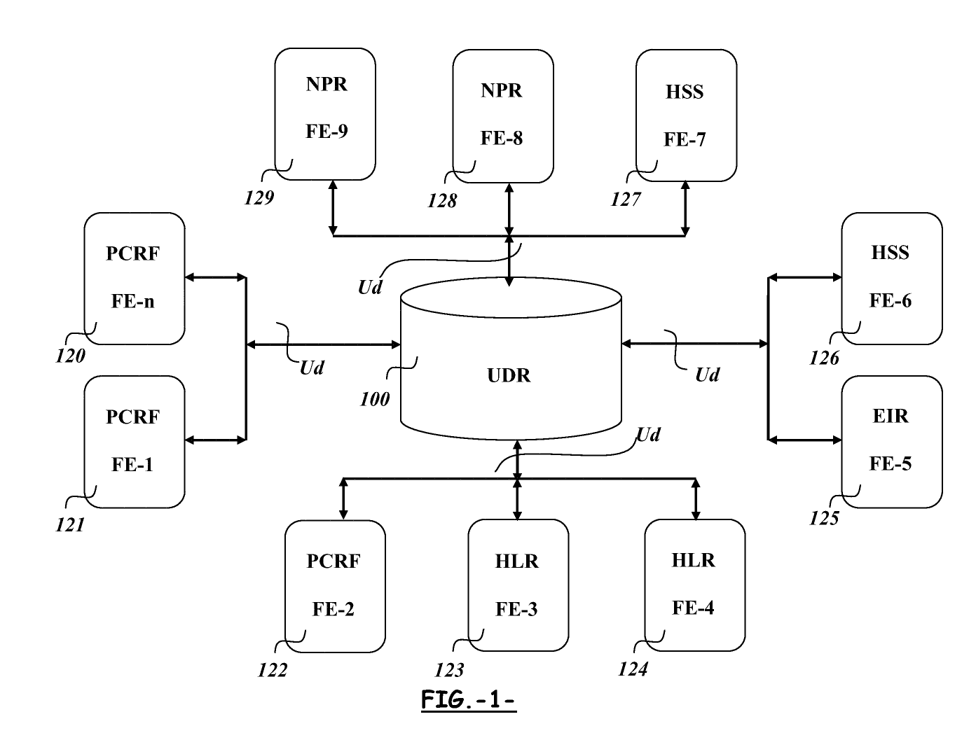

A generic and exemplary scenario wherein the method, UDR and FE servers of the present specification can be applied is illustrated in FIG. 1, which thus shows one or more PCRF-FE servers, one or more HLR-FE servers, one or more HSS-FE servers, one or more NPR-FE servers, and one or more EIR-FE servers. There is no limitation foreseen in the present specification to identify other natures of FE servers fitting the exemplary arrangement of FIG. 1.

In order to optimize the overall system, the different user data that different specific FE servers might operate on are preferably distributed in a plurality of sets of user data so as to ensure that one particular user data cannot belong to different sets and thus being operated separately and without controlling concurrency. In particular, a same set of user data may be operated by different FE servers handling different applications.

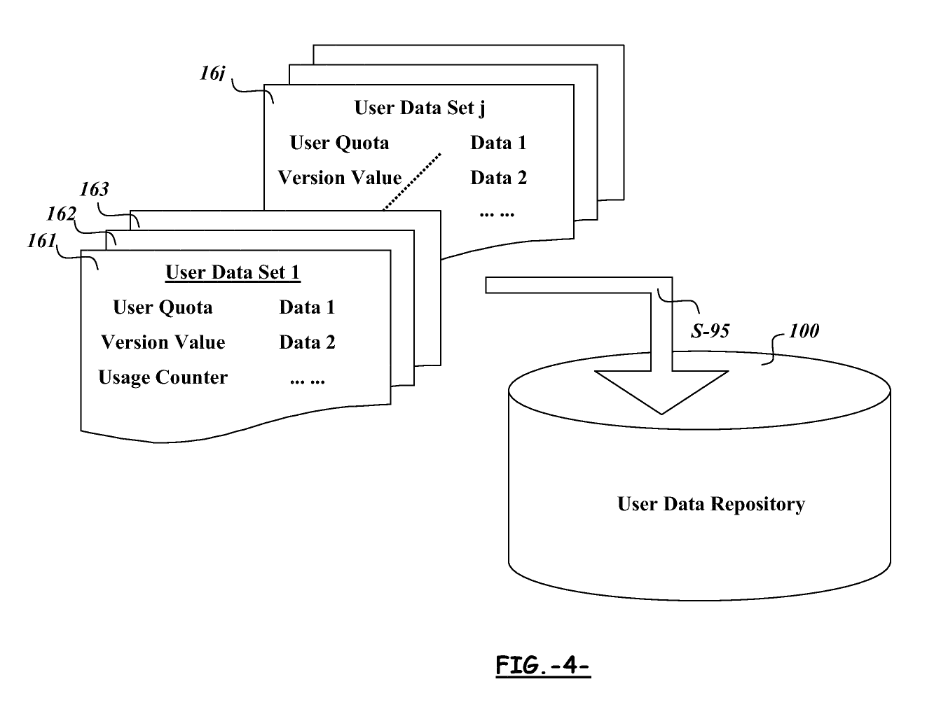

For this and other purposes, the UDR 100 may be configured during a step S-95 so that each set of user data 161-16j for a user is assigned a current version value, as illustrated in FIG. 4. To this end, the UDR 100 illustrated in FIG. 7 may further comprise storage 210 for assigning one or more sets of user data to respective one or more current version values for each user. Alternatively, the processing unit 220 of the UDR may be adapted for generating an initial version value to be used as current version value for any first LDAP search request to be received, such as the step S-100 in FIG. 2 may represent and which was said above to likely be a very first step to start the UDR up and running

In particular, this storage 210 may be implemented with a volatile memory such as a conventional RAM, which may be advantageous where the processing unit 220 of the UDR sets the initial value for any set of user data; or, where configuration of each set of user data for a user with a current version value is done during a step S-95, the storage 215 may preferably be implemented with a non-volatile memory, hard disk, optical disc, magnetic tape, holographic memory driver, a flash-memory or the like.

As already commented above, at least one FE server, amongst the one or more FE servers, includes an instance of a PCRF for controlling user quota and accumulated usage consumption for the user. Where this is the case, such FE server is referred to as a PCRF-FE server. For instance, FIG. 1 illustrates an UDC comprising PCRF-FE servers 120-122.

In an embodiment of the PCRF-FE server, the set of user data for the user may include one or more counters with accumulated usage consumptions. Also in this embodiment, the set of user data for the user may further include a user quota value indicating a maximum authorized for the accumulated usage consumptions.

In an alternative or complementary embodiment of the PCRF-FE server versus the previous one, one or more users may have a corporative subscription with a plurality of subscribers at the UDR. To this end, the storage 210 of the UDR is further configured to store all user data relevant to the corporative subscription. In particular, the corporative subscription may be a family, a company, a university, or the like.

For those users having a corporative subscription, the set of user data for each user may include one or more counters with accumulated usage consumptions for some or all subscribers in the corporative subscription. Apart from that, the set of user data for each user may further include a user quota value indicating a maximum authorized for the accumulated usage consumptions of the some or all subscribers in the corporative subscription.

Generally speaking, the sets of user data to be processed by a PCRF-FE server 120-122 may include any of: one or more counters for the corporative subscription, one or more counters for each member of the corporative subscription, one or more counters for each member of the corporative subscription and one or more counters for the corporative subscription, one or more counters for an individual user not member of any corporative subscription, and combinations thereof.

In the following, there is disclosed an exemplary application of some embodiments of the present specification where several PCRF-FE servers 120-122 are involved in carrying out a usage monitoring function.

As commented above, PCRF-FE servers 120-122 may handle counters with the accumulated usage consumption for a subscriber or for a corporative subscription (composed by a bunch of subscribers). These counters are stored in UDR 100 and read/updated by PCRF-FE servers through the Ud interface. The counters are updated every time the PCRF receives a report for usage consumption for a subscriber from a Policy and Charging Enforcement Function (PCEF) device 105 of a PCC architecture, and this is done by the PCEF device once a predefined amount of volume is consumed by each subscriber in the corporative subscription.

Moreover, since there may be more than one PCEF device in the PCC architecture, in the case of a corporative subscription including hundreds or thousands of subscribers, PCRF-FE servers may concurrently receive a considerable amount of usage consumption reports from the plurality of PCEF devices, all of them associated with a same counter in UDR.

The sequence of actions exemplary illustrated in FIG. 8A-8C shows a way to model the shared quota concept. There are several subscribers belonging to a family subscription that share a usage limit and whose consumption is tracked in a shared counter in order to detect when the limit is reached so in that moment, a PCRF-FE server can take decisions such as, for example, decrease the quality of service for on-going sessions related to the corporative subscription.

The sequence illustrated in FIG. 8A-8C starts with assuming a current version value ‘v’ during a step S-1, and a usage counter value of 50 Megabytes (Mb) during a step S-2. In this context, we may assume a user quota value 5 Gigabytes (Gb) to be shared by members of the corporative subscription.

During steps S-3 to S-16, Gx sessions ‘S1, S2 . . . Sm−1, Sm’ are initiated by the PCEF device 105 towards the different PCRF-FE servers 120-122 and for the different members (IMSI1, IMSI2 . . . ) belonging to the family subscription ‘A’. A particular PCRF-FE server may download 100 Mb, as it is the quota granted for each session of the family subscription, whenever the usage limit of 5 Gb is not reached. Prior to provide the answer in a CCA message towards the PCEF device 105, each PCRF-FE server retrieves a subscriber profile for the user from the UDR 100.

Depending on the slice quota, obtained from each PCRF-FE server 120-122 and downloaded to the PCEF device 105, and on the number of concurrent family members accessing the service, a significant number of usage monitoring Gx updates may be simultaneously received from the PCEF device.

Particularly during a step S-17, when the subscriber 1 consumes the granted quota of 100 Mb, the PCEF device 105 triggers a Usage monitoring Gx update for the session ‘S1’ towards the PCRF-FE1 server 121 reporting that 100 Mb have been consumed.

During the steps S-18 to S-21, the PCRF-FE1 server 121 is in charge of checking volume limits and, therefore, an access to the UDR 100 is required to read the current usage counter value for Family ‘A’ (50 Mb). The current version value, which is given with a VERS attribute value, is also received as part of LDAP search result and indicates VERS=‘v’.

During the step S-22, when subscriber 2 consumes the granted quota of 100 Mb, the PCEF device 105 triggers a Usage monitoring Gx update for the session ‘S2’ towards PCRF-FE2 server 122 reporting that 100 Mb have been consumed.

As for PCRF-FE1 server, during the steps S-23 to S-26, the PCRF-FE2 server 122 is in charge of checking volume limits and, therefore, an access to the UDR 100 is required to read the current usage counter value for Family ‘A’ (50 Mb). The current version value, which is given with the VERS attribute value, is also received as part of LDAP search result and indicates VERS=‘v’.

At a certain point in time represented by steps S-27 to S-30, the PCRF-FE2 server 122 decides that the current usage counter value for Family ‘A’ needs to be updated in the UDR with the reported usage for family member IMSI2 (100 Mb) and, therefore, the PCRF-FE2 server 122 sends an LDAP modify request towards the UDR 100 including the following indications: delete [attribute: VERS, value: V], which is the value previously read from the UDR and locally stored in the PCRF-FE2 server; replace [attribute: VERS, value: ‘v’+1], which is the new value to be set in the UDR; and replace [usage counter value for Family ‘A’ with new value: 150 Mb], which is the accumulated value of the previous 50 Mb value plus the recent consumption of 100 Mb.

Since the attribute VERS contains the value ‘v’ at the UDR, there is a match between the value accompanying the delete indication and the value stored at the UDR, and the LDAP modify request is thus successfully executed. As a result of receiving the successful LDAP modify result during the step S-30, the Usage monitoring Gx update is successfully answered from the PCRF-FE2 server 122 to the PCEF device 105 during the step S-31.

Then, during the steps S-32 to S-35, a further Usage monitoring Gx update procedure occurs for other sessions involving members of Family ‘A’, wherein an updating of the usage counter value for Family ‘A’ is carried out at the UDR without any collision, by following the same procedure based on the VERS attribute accompanying the delete indication, and resulting in a current VERS attribute value of ‘v’+‘m’−1, and a current usage counter value for Family ‘A’ of 3150 Mb.

Further, during the steps S-36 to S-45, a Usage monitoring Gx update, notifying of the 100 Mb quota having been exhausted, is received for a session ‘Sm’ in a PCRF-FEn server 120. The PCRF-FEn server 120 submits an LDAP search request to UDR 100 and retrieves in the LDAP search result the attribute VERS with current value ‘v’+‘m’−1 and the current usage counter value for Family ‘A’ of 3150 Mb.

Within this procedure, the PCRF-FEn server 120 submits a corresponding LDAP modify request towards the UDR 100, during the step S-41, in order to update the current usage counter value for Family ‘A’ with the reported usage for family member IMSIm (100 Mb). This LDAP modify request submitted towards the UDR 100 including the following indications: delete [attribute: VERS, value: ‘v’+‘m’−1], which is the value previously read from the UDR and locally stored in the PCRF-FEn server; replace [attribute: VERS, value: ‘v’+‘m’], which is the new value to be set in the UDR; and replace [usage counter value for Family ‘A’ with new value: 3250 Mb], which is the accumulated value of the previous 3150 Mb value plus the recent consumption of 100 Mb.

As for a previous session treated above, and since the attribute VERS contains the value ‘v’+‘m’−1 in the UDR, there is a match between the value accompanying the delete indication and the value stored at the UDR, and the LDAP modify request is thus successfully executed. As a result of receiving the successful LDAP modify result during the step S-44, the Usage monitoring Gx update is successfully answered from the PCRF-FEn server 120 to the PCEF device 105 during the step S-45.

Still further, during steps S-46 to S-49, the PCRF-FE1 server 121 detects that a modification of the usage counter value for Family ‘A’ is required, but the PCRF-FE1 server 121 triggers the modification after other concurrent processes have modified the current VERS attribute value at the UDR 100. A corresponding LDAP modify request is sent to the UDR 100 during a step S-47 in order to update the usage counter value for Family ‘A’ with the reported usage for family member IMSI1 (100 Mb).

This LDAP modify request takes into account those values which were originally read from the UDR, in step S-19, and thus includes the following indications: delete [attribute: VERS, value: ‘v’], which is the value previously read from the UDR and locally stored in the PCRF-FE1 server; replace [attribute: VERS, value: ‘v’+1], which is the new value to be set in the UDR; and replace [usage counter value for Family ‘A’ with new value: 150 Mb], which is the accumulated value of the previous 50 Mb value plus the recent consumption of 100 Mb.

This LDAP modify request fails at the UDR since the VERS attribute value ‘v’ submitted with the delete indication does not match the current VERS attribute value ‘v’+‘m’ stored at the UDR.

The UDR 100 thus rejects the LDAP modify request during the step S-48 with an error code ‘noSuchAttribute (16)’. The collision has been detected at the UDR and the modification of the counter is not permitted to prevent from maintaining inconsistent data. The attribute values remain at steps S-49 to 5-50 the same as were before at the UDR, that is, VERS=‘v’+‘m’, and usage counter value for Family ‘A’ with value 3250 Mb. The PCRF-FE1 server 121 has to reattempt the operation by reading again the subscriber profile.

To this end, during steps S-51 to S-58, the PCRF-FE1 server 121 submits an LDAP search request to UDR and retrieves with the LDAP search result the current VERS attribute value ‘v’+‘m’ stored at the UDR, and the usage counter value for Family ‘A’ with value 3250 Mb. Taking into account this data, the PCRF-FE1 server 121 sends a new LDAP modify request to the UDR in order to update the usage counter value for Family ‘A’ with the reported usage for family member IMSI1 (100 Mb).

This a new LDAP modify request submitted during the step S-55 includes the following indications: delete [attribute: VERS, value: ‘v’+‘m’], which is the value recently read from the UDR and locally stored in the PCRF-FE1 server; replace [attribute: VERS, value: ‘v’+‘m’+1], which is the new value to be set in the UDR; and replace [usage counter value for Family ‘A’ with new value: 3350 Mb], which is the accumulated value of the previous 3250 Mb value plus the recent consumption of 100 Mb.

This new LDAP modify request is successfully executed, since the attribute VERS contains the value ‘v’+‘m’ at the UDR, there is a match between the value accompanying the delete indication and the value stored at the UDR. As a result of receiving the successful LDAP modify result during the step S-58, the Usage monitoring Gx update is successfully answered from the PCRF-FE1 server 121 to the PCEF device 105 during the step S-59.

As shown in FIG. 8A to FIG. 8C and explained in the steps listed above, this mechanism may detect collisions due to a huge number of processes concurrently accessing to modify a same entry in the UDR while the bandwidth needed in the Ud interface and the computational resources of the UDR are extremely optimized. Both bandwidth and computational resources are always the same and do not depend on the number of concurrent processes accessing the entry.

The invention may also be practised by a computer program, loadable into an internal memory of a computer with input and output units as well as with a processing unit. This computer program comprises to this end executable code adapted to carry out the above method steps when running in the computer. In particular, the executable code may be recorded in a carrier readable means in a computer.

The invention is described above in connection with various embodiments that are intended to be illustrative and non-restrictive. It is expected that those of ordinary skill in this art may modify these embodiments. The scope of the invention is defined by the claims in conjunction with the description and drawings, and all modifications that fall within the scope of the claims are intended to be included therein.

1. A method of handling concurrent accesses at an entry in a user data repository, hereinafter UDR, wherein the entry in the UDR is concurrently accessed with Lightweight Directory Access Protocol, hereinafter LDAP, requests from one or more front-end servers equipped with respective LDAP-clients, the method comprising the steps of:
receiving, at the UDR from the one or more front-end servers, one or more LDAP search requests to read a set of user data for a user;
providing, from the UDR to the one or more front-end servers, the set of user data along with a current version value assigned to the set of user data;
each front-end server receiving the set of user data along with the current version value, processing the set of user data;
upon determining a modification of the set of user data, by a front-end server amongst the one or more front-end servers, said front-end server submitting to the UDR an LDAP modify request which includes: a first replace indication with new data to replace in the set of user data, a delete indication with the current version value, and a second replace indication with a new version value;
upon receiving the LDAP modify request, checking at the UDR whether the current version value received with the delete indication matches the current version value assigned at the UDR to the set of user data; and
where there is a match: replacing the current version value assigned at the UDR to the set of user data by the new version value received with the second replace indication, and replacing corresponding data in the set of user data by the new data received with the first replace indication; or
where there is not a match: rejecting the LDAP modify request.

2. The method of claim 1, further comprising a step of assigning one or more sets of user data to respective one or more current version values for each user at the UDR.

3. The method of claim 1, wherein after receiving at each front-end server the set of user data along with the current version value, the method further comprises a step of assigning (S-130, S-140) at each front-end server the current version value to the set of user data.

4. The method of claim 1, further comprising a step of determining at the front-end server, during or after processing the set of user data received, the new data to replace in the set of user data and the new version value.

5. The method of claim 1, further comprising a step of assigning to each of the one or more front-end servers a set of new version values to be used for successive LDAP modify requests, the set of new version values being different for each of the one or more front-end servers.

6. The method of claim 1, wherein at least one front-end server, amongst the one or more front-end servers, includes an instance of a Policy and Charging Rules Function for controlling user quota and accumulated usage consumption for the user.

7. The method of claim 6, wherein the set of user data for the user includes one or more counters with accumulated usage consumptions.

8. The method of claim 7, wherein the set of user data for the user includes a user quota value indicating a maximum authorized for the accumulated usage consumptions.

9. The method of claim 6, wherein the user has a corporative subscription with a plurality of subscribers at the UDR.

10. The method of claim 9, wherein the set of user data for the user includes one or more counters with accumulated usage consumptions for some or all subscribers in the corporative subscription.

11. The method of claim 10, wherein the set of user data for the user includes a user quota value indicating a maximum authorized for the accumulated usage consumptions of the some or all subscribers in the corporative subscription.

12. A user data repository, hereinafter UDR, for handling concurrent accesses with Lightweight Directory Access Protocol, hereinafter LDAP, requests at an entry in the user data repository, from one or more front-end servers equipped with respective LDAP-clients, the UDR comprising:
a receiver for receiving, from the one or more front-end servers, one or more LDAP search requests to read a set of user data for a user;
a sender for providing, to the one or more front-end servers, the set of user data along with a current version value assigned to the set of user data;
the receiver adapted for receiving, from at least one amongst the one or more front-end servers, an LDAP modify request which includes: a first replace indication with new data to replace in the set of user data, a delete indication with the current version value, and a second replace indication with a new version value;
a processing unit for checking whether the current version value received with the delete indication matches the current version value assigned at the UDR to the set of user data; and
where there is match, the processing unit adapted for: replacing the current version value assigned at the UDR to the set of user data by the new version value received with the second replace indication, and replacing corresponding data in the set of user data by the new data received with the first replace indication; or
where there is not a match, the processing unit and the sender adapted for: rejecting the LDAP modify request.

13. The UDR of claim 12, further comprising storage for assigning one or more sets of user data to respective one or more current version values for each user.

14. The UDR of claim 12, wherein at least one front-end server, amongst the one or more front-end servers, includes an instance of a Policy and Charging Rules Function for controlling user quota and accumulated usage consumption for the user.

15. The UDR of claim 14, wherein the set of user data for the user includes one or more counters with accumulated usage consumptions.

16. The UDR of claim 15, wherein the set of user data for the user includes a user quota value indicating a maximum authorized for the accumulated usage consumptions.

17. The UDR of claim 14, wherein the user has a corporative subscription with a plurality of subscribers configured in the storage of the UDR.

18. The UDR of claim 17, wherein the set of user data for the user includes one or more counters with accumulated usage consumptions for some or all subscribers in the corporative subscription.

19. The UDR of claim 18, wherein the set of user data for the user includes a user quota value indicating a maximum authorized for the accumulated usage consumptions of the some or all subscribers in the corporative subscription.

20. A front-end server for accessing an entry in a user data repository, hereinafter UDR, with a Lightweight Directory Access Protocol, hereinafter LDAP, the front-end server equipped with an LDAP-client and comprising:
a sender for submitting to the UDR one or more LDAP search requests to read a set of user data for a user;
a receiver for receiving the set of user data along with a current version value for the set of user data;
a processing unit for processing the set of user data, and for determining a modification of the set of user data; and
the sender adapted for submitting to the UDR an LDAP modify request which includes: a first replace indication with new data to replace in the set of user data, a delete indication with the current version value, and a second replace indication with a new version value.

21. The front-end server of claim 20, further comprising storage for assigning the current version value to the set of user data.

22. The front-end server of claim 20, wherein the processing unit is adapted for determining the new data to replace in the set of user data, and for determining the new version value to be assigned to the set of user data.

23. The front-end server of claim 20, wherein the storage is adapted for storing a set of version values assigned to the front-end server and to be used as new version values for successive LDAP modify requests.

24. The front-end server of claim 20, further including an instance of a Policy and Charging Rules Function for controlling user quota and accumulated usage consumption for the user.

25. The front-end server of claim 24, wherein the set of user data for the user includes one or more counters with accumulated usage consumptions.

26. The front-end server of claim 25, wherein the set of user data for the user includes a user quota value indicating a maximum authorized for the accumulated usage consumptions.

27. The front-end server of claim 24, wherein the user has a corporative subscription with a plurality of subscribers at the UDR.

28. The front-end server of claim 27, wherein the set of user data for the user includes one or more counters with accumulated usage consumptions for some or all subscribers in the corporative subscription.

29. The front-end server of claim 28, wherein the set of user data for the user includes a user quota value indicating a maximum authorized for the accumulated usage consumptions of the some or all subscribers in the corporative subscription.
